(19) United States
(12) Patent Application Publication
(10) Pub. No.: US 2012/0026192 A1
(43) Pub. Date: Feb. 2, 2012

(54) APPARATUS AND METHOD FOR PROVIDING AUGMENTED REALITY (AR) USING USER RECOGNITION INFORMATION

(75) Inventor: Oh-Seob LIM, Suwon-si (KR)

(73) Assignee: PANTECH CO., LTD., Seoul (KR)

(21) Appl. No.: 13/150,746

(22) Filed: Jun. 1, 2011

(30) Foreign Application Priority Data
Jul. 28, 2010 (KR) 10-2010-0073053

(51) Int. Cl. G09G 5/00

(52) U.S. Cl. 345/633

(57) ABSTRACT

An apparatus and method for providing Augmented Reality (AR) using user recognition information includes: acquiring user recognition information for a real object; selecting a virtual object that is to be mapped to the acquired user recognition information; and adding the user recognition information as mapping information for the selected virtual object.

### CROSS-REFERENCE TO RELATED APPLICATION

This application claims the priority and the benefit under 35 U.S.C. §119(a) of a Korean Patent Application No. 10-2010-0073053, filed on Jul. 28, 2010, which is incorporated by reference for all purposes as if fully set forth herein.

### BACKGROUND

1. Field

The following disclosure is directed to providing augmented reality, and more particularly, to processing recognition information to map real objects to virtual objects in order to provide augmented reality.

2. Discussion of the Background

Augmented Reality (AR) is a computer graphic technique of synthesizing a virtual object or virtual information with a real environment such that the virtual object or virtual information looks like a real object or real information that exists in the real environment.

AR is characterized by synthesizing virtual objects based on a real world to provide additional information that cannot easily be obtained from the real world. AR is thus unlike existing Virtual Reality (VR), which targets virtual spaces and virtual objects. Due to the characteristic of AR, unlike the existing VR that has been applied to limited fields such as games, AR can be applied to various real environments.

An AR providing apparatus maps a virtual object to a real object using recognition information of the real object, such as mapping information. For example, an AR providing apparatus may acquire recognition information for a red rose, and detect “information about flower festivals” mapped to the acquired recognition information, subsequently providing the “information about flower festivals” to a user. In the AR providing apparatus, real objects or their recognition information, which are used as mapping information for detecting virtual objects, are defined in advance. For example, recognition information for a red rose is designated as mapping information of a virtual object “information about flower festivals” and accordingly recognition information for a yellow rose will fail to detect “information about flower festivals”. If only the red color and outline among the red color, outline and scent of the Rose, included in the recognition information of the red rose, are designated as recognition information for detecting a virtual object, information about the scent of the rose will fail to detect the “information about flower festivals”.

In other words, since mapping information for detecting a virtual object is based on the recognition information of a specific real object or to specific recognition information of a specific real object, there is an inability to provide an AR service using various real objects having the similar attributes or various shared pieces of recognition information of a real object.

### SUMMARY

The following description relates to an apparatus and method that can add recognition information for real objects as mapping information for detection virtual objects.

The following description also relates to an apparatus and method that can detect virtual objects using added recognition information for real objects.

The following description also relates to an apparatus and method that can correct or delete added recognition information for real objects.

Exemplary embodiments of the present invention provide an Augmented Reality (AR) providing apparatus, including a recognition information acquiring unit to acquire user recognition information from a real object and to output the user recognition information; a manipulating unit to receive a signal for requesting an addition to the user recognition information; and a controller to select a virtual object, and to add the outputted user recognition information as mapping information for the virtual object.

Exemplary embodiments of the present invention also provides an Augmented Reality (AR) providing apparatus, including a communication unit to exchange information with a terminal through a wired or wireless communication network; a database to store recognition information mapped to a virtual object; and a controller to store user recognition information transmitted from the terminal, the user recognition information used for recognizing the virtual object in the database.

Exemplary embodiments of the present invention also provides a method for providing Augmented Reality (AR), including acquiring user recognition information for a real object; a virtual object to be mapped to the user recognition information; a virtual object to be mapped to the user recognition information; and mapping the user recognition information with the virtual object.

Exemplary embodiments of the present invention also provides a method for providing Augmented Reality (AR) using user recognition information in a server that is connectable to a terminal through a wired or wireless communication network, the method including receiving a signal for requesting addition of user recognition information from the terminal; and storing the user recognition information as mapping information with a virtual object stored in the server.

Exemplary embodiments of the present invention also provides an Augmented Reality (AR) providing terminal, the terminal including a communication unit to exchange information with an external server that stores a virtual object mapped with reference recognition information; a recognition information acquiring unit to acquire user recognition information from a real object and to output the user recognition information; a manipulating unit to receive a signal for requesting addition of user recognition information; user recognition information database to store the user recognition information; a reference recognition information database to store reference recognition information mapped to the virtual object; and a controller to select the virtual object from the external server to be mapped to recognition information output from the recognition information acquiring unit, and to map the reference recognition information to the virtual object, and to store the reference recognition information mapped to the virtual object.

Exemplary embodiments of the present invention also provides an Augmented Reality (AR) providing apparatus, including a communication unit to receive and to transmit is information from and to a terminal through a wired or wireless communication network; a database to store reference recognition information mapped to a virtual object; and a controller to detect the reference recognition information from the database and to transmit the detected reference recognition information to the terminal.

Exemplary embodiments of the present invention also provides a method for providing Augmented Reality (AR) in a terminal that provides AR to an external server storing reference recognition information, the method including acquiring user recognition information for a real object; selecting a virtual object to be mapped to the acquired user recognition information by exchanging information with the external server; detecting reference recognition information mapped to the virtual object; and mapping the reference recognition information with the user recognition information, and storing the result of the mapping.

Additional features of the invention will be set forth in the description which follows, and in part will be apparent from the description, or may be learned by practice of the invention.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system including an augmented reality (AR) is providing apparatus using additional recognition information according to an exemplary embodiment of the present invention.

FIG. 2 is a signal flow diagram of a terminal interacting with a server according to an exemplary embodiment of the present invention.

FIG. 3 is a signal flow diagram of a terminal interacting with a server according to an exemplary embodiment of the present invention.

FIG. 4 is a diagram illustrating a system including an AR providing apparatus using additional recognition information according to an exemplary embodiment of the present invention.

FIG. 5 is a signal flow diagram of a terminal interacting with a server according to an exemplary embodiment of the present invention.

FIG. 6 is a signal flow diagram of a terminal interacting with a server according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In this disclosure, a technique for adding recognition information for a real object designated by a user as mapping information for detecting a specific virtual object, in addition to pre-defined recognition information for the real object, in order to detect a virtual object associated with the real object using the added recognition information is provided. An augmented reality (AR) providing apparatus to display AR data may be associated with an apparatus that can recognize real objects including, but not limited to, personal computers, such as a desk-top computer, a notebook or the like; mobile communication terminals, such as Personal Digital Assistants (PDA), a smart phone, a navigation terminal. Also, in this disclosure, the pre-defined real object recognition information is referred to as reference recognition information and the added real object recognition information is referred to as user recognition information. Also, this disclosure contains examples of a communication system where an AR providing terminal (hereinafter, simply referred to as a “terminal”) is connected to an AR providing server (hereinafter, simply referred to as a “server”) through a communication network. However, this is only exemplary. Various AR providing methods, apparatuses and systems may be realized based on the disclosure contained herein.

Also, in this disclosure, various examples are disclosed according to the location of a recognition information database.

A first example is directed to a recognition information database being located in a server with storage and processing of user recognition information being performed by the server. The second example is directed to a recognition information database being located in a terminal with storage and processing of user recognition information being performed by the terminal.

### First Example

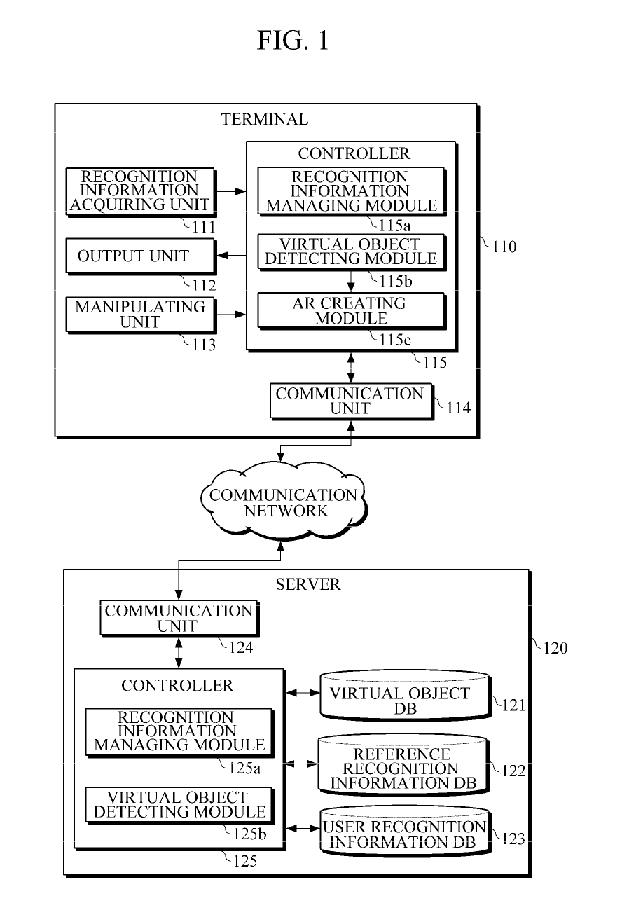

FIG. 1 is a diagram illustrating a system including an augmented reality (AR) providing apparatus using additional recognition information according to an exemplary embodiment of the present invention.

Referring to FIG. 1, the communication system includes at least one AR providing terminal 110 (hereinafter, simply referred to as a “terminal”) and an AR providing server 120 (hereinafter, simply referred to as a “server”), wherein the server 120 may be connected to the terminal 110 through a wired or wireless communication network and provides information for AR services to the terminal 110.

The terminal 110 includes a recognition information acquiring unit 111, a manipulating unit 113 and a controller 115 and may further include an output unit 112 and a communication unit 114.

The recognition information acquiring unit 111 acquires recognition information pertaining to real objects and outputs the acquired recognition information. Here, the real objects may refer to objects or states existing in the real world. That is, the real objects may mean s anything that can be defined in the real world, including locations, climate, speed, etc. as well as visual, auditory and olfactory data. The recognition information acquiring unit 111 may further include a real object data acquiring unit (not shown) and a recognition information sampling unit (not shown). The real object data acquiring unit may be a camera, an image sensor, a microphone, an olfactory data sensor, a GPS sensor, a Geo-magnetic sensor, a speed sensor or the like. The recognition information sampling unit extracts information that is output from the real object data acquiring unit, that is to be used as recognition information from real object data (for example, images, sound data, location data, direction data or speed data).

The output unit 112 may output AR data received from the controller 115. Here, AR data is obtained by recognizing real objects and may be data created by synthesizing a real is object with a virtual object, or may be data consisting of virtual objects. The output unit 112 may include a display for outputting visual data, a speaker for outputting sound data in the form of audible sound, etc.

The manipulating unit 113 is an interface that may receive user information and may include a key input panel, a touch screen, a microphone, and the like. At least one of information for requesting addition of user recognition information, information for selecting a virtual object, and information for requesting detection of a virtual object may be received from a user through the manipulating unit 113 and then output to the controller 115. In addition, the manipulating unit 113 may receive information for correcting user recognition information or information for deleting user recognition information, and subsequently output the received information to the controller 115.

The communication unit 114 may process external signals received through the wired or wireless communication network and internal signals. The communication unit 114 may receive and process virtual objects from the server 120 and output the resultant virtual objects to the controller 115. The communication unit 114 may process information for requesting registration of user recognition information or information for requesting detection of virtual objects, received from the controller 115, and transmit the result of the processing to the server 120.

The controller 115 may control the internal components of the terminal 110 to perform a function of adding user recognition information to map objects. In addition, the controller 115 performs a function of correcting or deleting the user recognition information. Also, the controller 115 may control detection of virtual objects using the user recognition information based on a request from a user.

The controller 115 may include a recognition information managing module 115a, a virtual object detecting module 115b, and an AR creating module 115c.

If receiving a signal for requesting registration of user recognition information from the manipulating unit 113 and user recognition information from the object recognition unit 111, the recognition information managing module 115a may connect to the server 120 and control the server 120 to register the user recognition information as mapping information for detecting a specific virtual object. Also, the recognition information managing module 115a may support a request for correcting or deleting the user recognition information from the manipulating unit 113.

If receiving a signal for requesting detection of a virtual object associated with recognition information received from the manipulating unit 113, the virtual object detecting module 115b accesses the server 120 and acquires a virtual object corresponding to the recognition information from the server 120. The AR creating module 115c may synthesize the virtual object received from the server 120 with a real object or create AR data using not using a real object, and may output the result of the synthesis or the created AR data to the output unit 112.

The server 120 may include a virtual object DB 121, a reference recognition information DB 122, an additional recognition information DB 123, a communication unit 124 and a controller 125.

The virtual object DB 121 stores virtual objects that are supplemental information associated with real objects. For example, if the Louvre museum is a real object, architectural information about the Louvre museum, moving images of collections of the Louvre museum, view guide broadcasting, etc. may correspond to virtual objects that are supplemental to the real is object (in the case the Louvre museum). Identifiers for identifying the virtual objects may be assigned to the virtual objects.

The reference recognition information DB 122 may store recognition information designated in advance to be mapped to the virtual objects, with the user recognition information DB 123 storing recognition information that is additionally designated by a user to be mapped to the virtual objects. The reference recognition information DB 122 may store recognition information extracted from real objects as mapping information for detecting virtual objects. Mapping information for detecting a virtual object “flower festival moving picture”, a rose shape that is a feature of a real object rose, may be designated as reference recognition information and stored in the reference recognition information DB 122. The user recognition information DB 123 stores recognition information according to a request from a user in addition to the reference recognition information. For example, although a rose shape is designated as reference recognition information for detecting a virtual object “flower festival moving picture”, a tulip shape, a cosmos shape, etc. may be stored as user recognition information in the user recognition information DB 123 based on a request from a user. The user recognition information may be at least one piece of extracted information for one or more real objects. Also, recognition information that is stored in the reference recognition information DB 122 and user recognition information DB 123 to map virtual objects may be assigned identifiers corresponding to virtual objects.

The communication unit 124 may process the external signals received through the wired or wireless communication network in addition to internal signals. The communication unit 124 receives and processes a signal for requesting management of recognition information and the recognition information from the terminal 110, and outputs the received and processed signal and recognition information to the controller 125. In addition, the communication unit 124 may receive information for searching for virtual objects and detected virtual object data from the controller 125, process the virtual object data, and transmit the result of the processing to the terminal 110.

The controller 125 may include a recognition information managing module 125a and a virtual object detecting module 125b. The recognition information managing module 125a registers, if it receives recognition information from the terminal 110 through the communication unit 124 with a signal for requesting registration of user recognition information, the received recognition information as mapping information for identifying a specific virtual object. Thus, the recognition information managing module 125a may assign an identifier of a virtual object selected by the terminal 110 to the received recognition information, and store the recognition information in the user recognition information DB 123. The virtual object detecting module 125b detects, if it receives a request for detecting a virtual object from the terminal 110, a virtual object corresponding to the received recognition information and transmits the virtual object to the terminal 110. Thus, the virtual object detecting module 125b searches the reference recognition information DB 122 and the user recognition information DB 123 to detect an identifier based on the received recognition information, and retrieves a virtual object having the detected identifier from the virtual object DB 121.

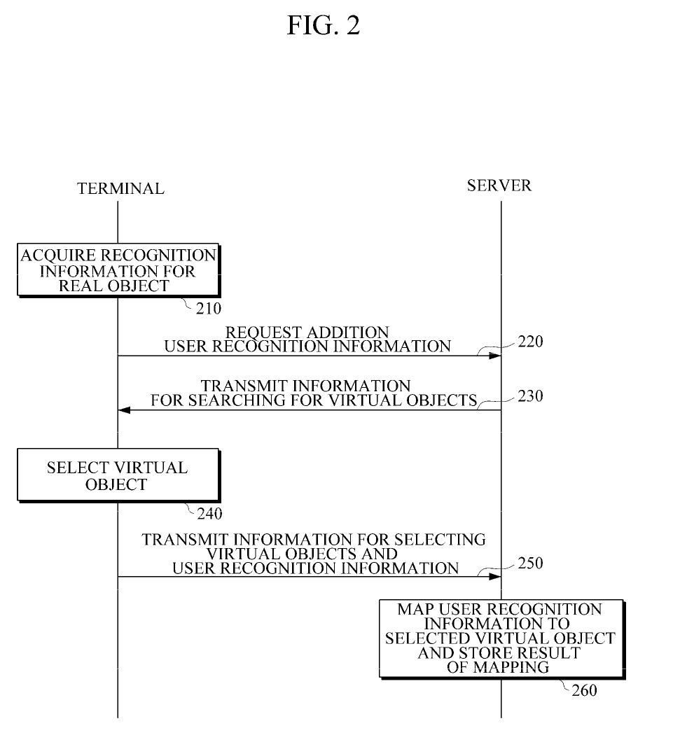

FIG. 2 is a signal flow diagram of a terminal interacting with a server according to an exemplary embodiment of the present invention.

Referring to FIG. 2, a terminal acquires recognition information for a real object (operation 210). This may include, but is not limited to, the terminal extracting characteristic information such as, outlines and colors, of the real object and assigning this as recognition information. The real object may be an object of interest contained in an image sourced from a photograph or camera.

The terminal may transmit a signal for requesting addition of user recognition information to a server (operation 220). After which, the server may transmit information for searching for virtual objects to the terminal (operation 230). The information for searching for virtual objects may include, but is not limited to, information for classifying virtual objects or a web page for searching for virtual objects.

The terminal may select a virtual object that is to be mapped to the recognition information acquired in operation 210 by using the information for searching for virtual objects (operation 240), and may transmit the information for selecting virtual objects and the user recognition information to the server (operation 250).

The server may store the recognition information received from the terminal as user recognition information to be mapped to the selected virtual object (operation 260). In order to map the user recognition information to the selected virtual object, the user recognition information may be assigned the same identifier as that already assigned to the selected virtual object.

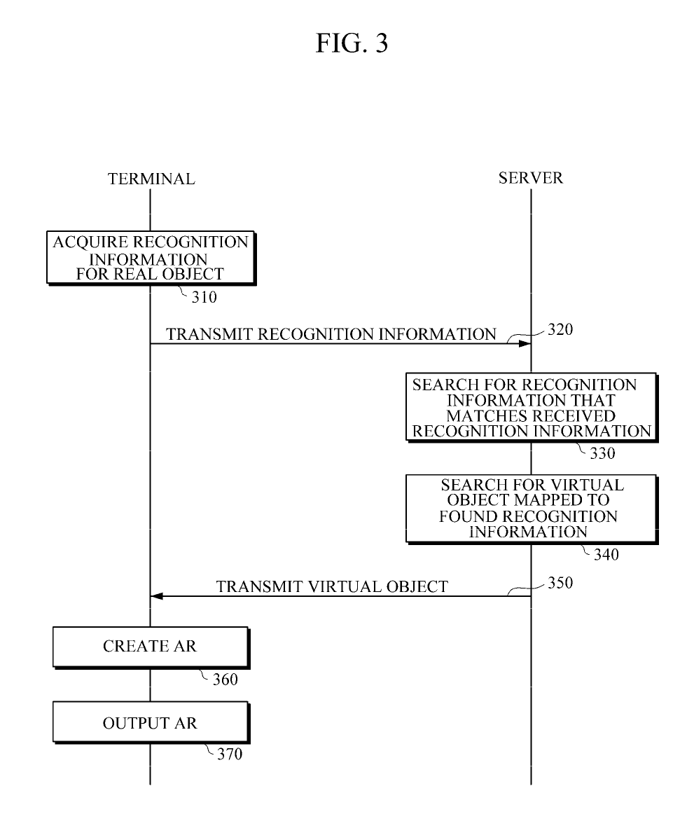

FIG. 3 is a signal flow diagram of a terminal interacting with a server according to an exemplary embodiment of the present invention.

A terminal may acquire recognition information for a specific real object (operation 310) and may transmit the recognition information to a server to request a virtual object to be mapped to the recognition information stored in the server (operation 320).

The server may search for recognition information that matches or is similar to the received recognition information (operation 330). If the recognition information is found, the server searches for a virtual object mapped to the found recognition information (operation 340). Thus, the server searches for information about a virtual object to which the same identifier as that of the found recognition information has been assigned.

If a virtual object is found in operation 340, the server may transmit the found virtual object information to the terminal (operation 350). The terminal synthesizes the received virtual object with the real object or creates AR data using only the virtual object (operation 360), and may output the AR data (operation 370).

### Second Example

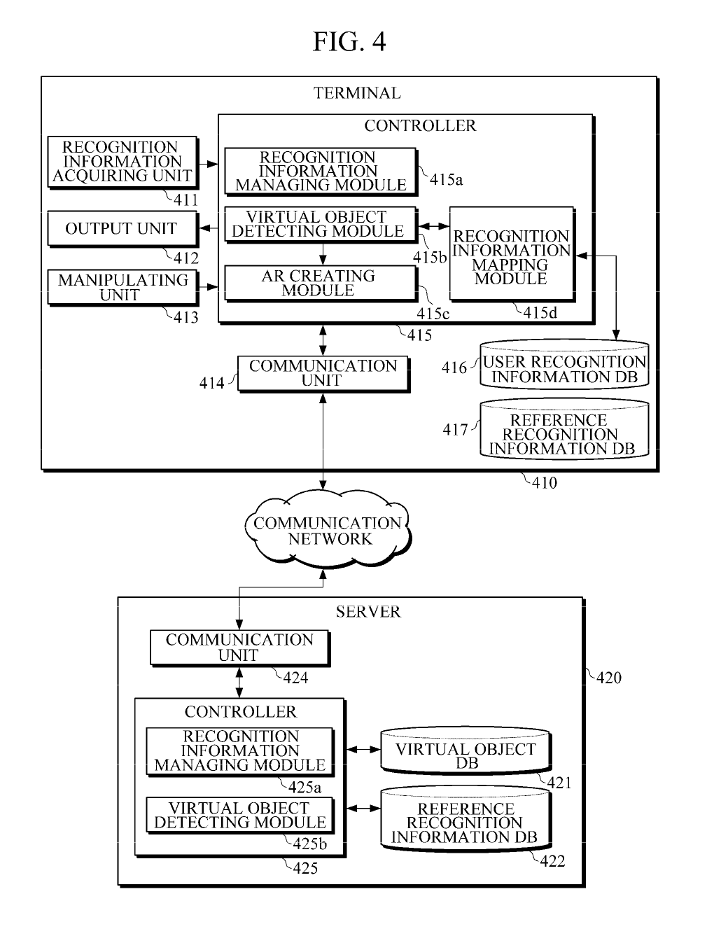

FIG. 4 is a diagram illustrating a system including an AR providing apparatus using additional recognition information according to an exemplary embodiment of the present invention. In the following description, similar components and operations as those disclosed in the communication system illustrated in FIG. 1 have been described above with respect to FIG. 1, and will not be described again.

Referring to FIG. 4, user recognition information DB 416 and reference recognition information DB 417 may be included in a terminal 410. In FIG. 4, the DBs 416 and 417 are shown to be installed in the terminal 410, however, the DBs 416 and 417 may also and additionally be outside the terminal 410.

Accordingly, a recognition information managing module 415a that may be included in a controller 415 may store acquired user recognition information in the user recognition information DB 416, thus obviating a transmission to the server 420. Since the user recognition information is located in the terminal 410, the terminal 410 may not be able to acquire a desired virtual object using the stored user recognition information, if the desired virtual object is located in the server 420. Accordingly, the recognition information managing module 415a may further perform a copy function of copying reference recognition information used in the server 420 and storing the reference recognition information in the terminal 410. Thus, the recognition information managing module 415a detects reference recognition information for a specific virtual object, maps the reference recognition information to user recognition information and stores the result of the mapping. For example, the recognition information managing module 415a may map the reference recognition information to the user recognition information by assigning the same identifier to both the reference recognition information and user recognition information, thus linking the information together.

The virtual object detection module 415b requests, if it receives a signal for requesting detection of a virtual object corresponding to the recognition information received from a recognition information acquiring unit 411 from a manipulating unit 413, detection of reference recognition information to be mapped to the recognition information by a recognition information mapping module 415d. The recognition information mapping module 415d searches for an identifier associated with the received recognition information from the user recognition DB 416 and searches for reference recognition information to which the found identifier is assigned from the reference recognition information DB 417. Then, the recognition information mapping module 415d accesses the server 420 to acquire a virtual object corresponding to the reference recognition information.

The If the terminal 410 requests addition of user recognition information with a communication unit 424, a recognition information managing module 425a of a controller 425 detects reference recognition information for a specific virtual object and transmits the reference recognition information to the terminal 410. If the terminal 410 requests detection of a virtual object by transmitting reference recognition information, the virtual object detecting module 425b detects a virtual object corresponding to the received reference recognition information and transmits the detected virtual object to the terminal 410.

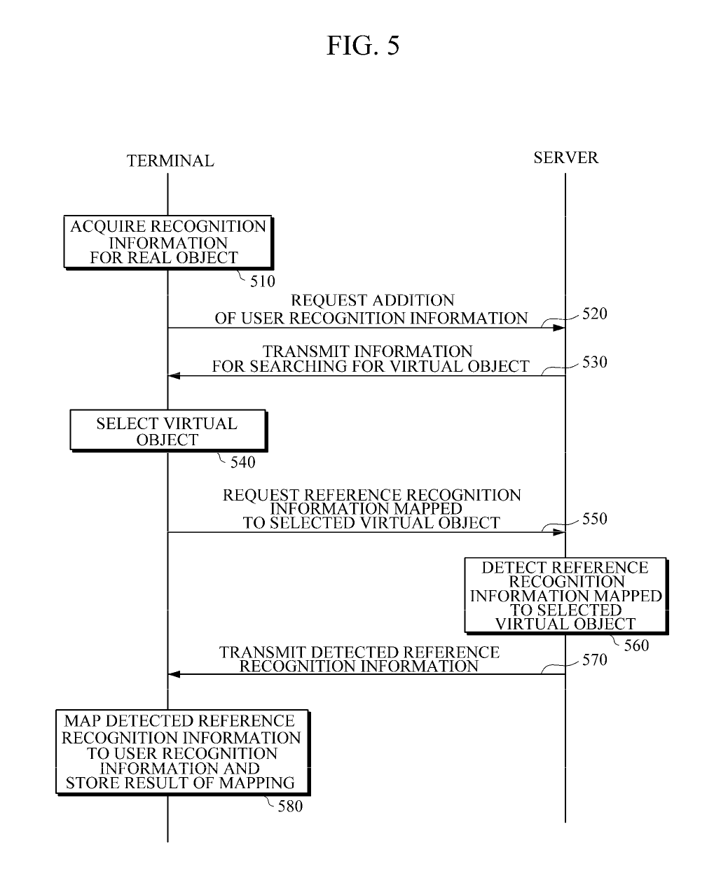

FIG. 5 is a signal flow diagram of a terminal interacting with a server according to an exemplary embodiment of the present invention.

Referring to FIG. 5, a terminal acquires user recognition information for a real object (operation 510). The terminal transmits a signal for requesting addition of user recognition information to a server (operation 520). The server transmits information for searching for a virtual object to the terminal (operation 530). The terminal selects a virtual object based on the information of operation 510 through 530, the virtual object being mapped to the user recognition information acquired in operation 510 using the information for searching for the virtual object (operation 540), and requests reference recognition information mapped to the selected virtual object to the server (operation 550).

Accordingly, the server detects reference recognition information mapped to the selected virtual object (operation 560) and then transmits the detected reference recognition information to the terminal (operation 570). The terminal maps the received reference recognition information to the user recognition information and stores the result of the mapping (operation 580). This mapping may be stored in a database in either the terminal or server.

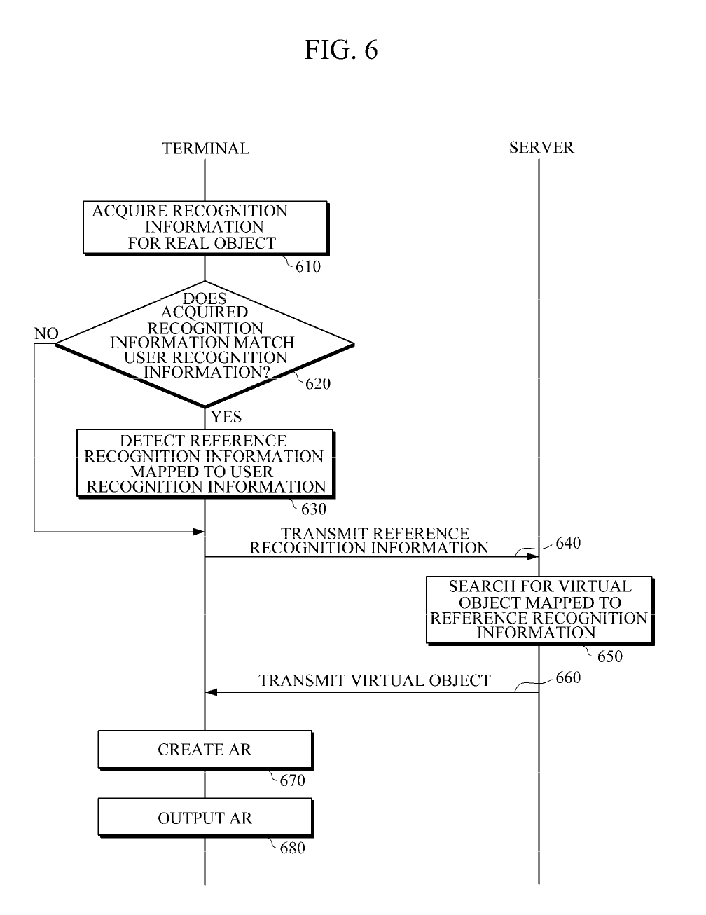

FIG. 6 is a signal flow diagram for explaining of a terminal interacting with a server according to an exemplary embodiment of the present invention.

Referring to FIG. 6, a terminal acquires recognition information for a real object (operation 610) and searches for recognition information that matches the acquired recognition information (operation 620). If the acquired recognition information is identical or similar to user recognition information, the terminal detects reference recognition information mapped to the user recognition information (operation 630). If it is determined in operation 620 that the acquired recognition information is reference recognition information, the process proceeds to operation 640.

The terminal transmits the reference recognition information to a server (operation 640) and requests a virtual object mapped to the reference recognition information to the server (operation 640). The server searches for information related to a virtual object mapped to the received reference recognition information (operation 650). The server may search for a virtual object with a similar identifier assigned to the found recognition information.

The server transmits the found virtual object to the terminal (operation 660). The terminal synthesizes the received virtual object with the real object or creates AR data using only the virtual object (operation 670), and may output the created AR data (operation 680).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components and their equivalents. Accordingly, other implementations are within the scope of the following claims and their equivalents.

What is claimed is:

1. An Augmented Reality (AR) providing apparatus, comprising:
a recognition information acquiring unit to acquire user recognition information from a real object and to output the user recognition information;
a manipulating unit to receive a signal for requesting an addition to the user recognition information; and
a controller to select a virtual object, and to add the outputted user recognition information as mapping information for the virtual object.

2. The AR providing apparatus of claim 1, wherein the user recognition information is information extracted manually from one or more real objects.

3. The AR providing apparatus of claim 1, further comprising a communication unit to exchange information to a server, the server storing at least one virtual object and reference recognition information mapped to the at least one virtual object,
wherein the controller accesses the server through the communication unit to request registration of the user recognition information to the server.

4. An Augmented Reality (AR) providing apparatus, comprising:
a communication unit to exchange information with a terminal through a wired or wireless communication network;
a database to store recognition information mapped to a virtual object; and
a controller to store user recognition information transmitted from the terminal, the user recognition information used for recognizing the virtual object in the database.

5. The AR providing apparatus of claim 4, wherein the database comprises:
a reference recognition information database to store reference recognition information mapped to the virtual object; and
a user recognition information database to store user recognition information, the user recognition information being designated by a user to be mapped to the virtual object.

6. The AR providing apparatus of claim 4, wherein if the terminal requests addition of user recognition information, the controller transmits information for searching for a virtual object to the terminal.

7. A method for providing Augmented Reality (AR), comprising:
acquiring user recognition information for a real object;
selecting a virtual object to be mapped to the user recognition information; and
mapping the user recognition information with the virtual object.

8. The method of claim 7, wherein the user recognition information is information extracted manually for one or more real objects.

9. A method for providing Augmented Reality (AR) using user recognition information in a server that is connectable to a terminal through a wired or wireless communication network, the method comprising:
receiving a signal for requesting addition of user recognition information from the terminal; and
storing the user recognition information as mapping information with a virtual object stored in the server.

10. The method of claim 9, further comprising:
transmitting information for searching for a virtual object to the terminal.

11. An Augmented Reality (AR) providing terminal, the terminal comprising:
a communication unit to exchange information with an external server that stores a virtual object mapped with reference recognition information;
a recognition information acquiring unit to acquire user recognition information from a real object and to output the user recognition information;
a manipulating unit to receive a signal for requesting addition of user recognition information;
a user recognition information database to store the user recognition information;
a reference recognition information database to store reference recognition information mapped to the virtual object; and
a controller to select the virtual object from the external server to be mapped to recognition information output from the recognition information acquiring unit, and to map the reference recognition information to the virtual object, and to store the reference recognition information mapped to the virtual object.

12. The AR providing terminal of claim 11, wherein if a signal for requesting a virtual object from the manipulating unit, and if recognition information acquired by the recognition information acquiring unit is user recognition information, the controller detects reference recognition information mapped to the user recognition information and transmits the detected reference recognition information to the server through the communication unit for the requesting of the virtual object.

13. An Augmented Reality (AR) providing apparatus, comprising:
a communication unit to receive and to transmit information from and to a terminal through a wired or wireless communication network;
a database to store reference recognition information mapped to a virtual object; and
a controller to detect the reference recognition information from the database and to transmit the detected reference recognition information to the terminal.

14. A method for providing Augmented Reality (AR) in a terminal that provides AR to an external server storing reference recognition information, the method comprising:
acquiring user recognition information for a real object;
selecting a virtual object to be mapped to the acquired user recognition information by exchanging information with the external server;
detecting reference recognition information mapped to the virtual object; and
mapping the reference recognition information with the user recognition information, and storing the result of the mapping.

15. The method of claim 14, further comprising:
comparing additional recognition information with the user recognition information;
detecting, if the received recognition information is identical to the user recognition information, reference recognition information mapped to the user recognition information; and
transmitting the reference recognition information to the server to request the virtual object from the server.

16. A method for providing Augmented Reality (AR) through a wired or wireless communication network, the method comprising:
receiving a request for reference recognition information mapped to a virtual object from a terminal;
detecting reference recognition information mapped to the virtual object; and
transmitting the reference recognition information to the terminal.

17. The AR providing apparatus of claim 1, wherein the controller selects a virtual object if receiving the signal for requesting addition of user recognition information from the manipulating unit.

18. The method of claim 10, wherein the transmitting occurs if a signal for requesting addition of user recognition information from the terminal is received.

19. The AR providing terminal of claim 11, wherein the controller selects the virtual object if a signal for requesting addition of user recognition information from the manipulating unit is received.

20. The AR providing apparatus of claim 13, wherein the controller detects the reference recognition information if a request for reference recognition information regarding a virtual object from a terminal through the communication unit is received.
